(19) United States
(12) Patent Application Publication
(10) Pub. No.: US 2010/0243379 A1
(43) Pub. Date: Sep. 30, 2010

(54) BUFFER ARRANGEMENT AND BUFFER STOP OF AN ELEVATOR

(76) Inventor: Juha Taavela, Lammi (FI)

Correspondence Address: BIRCH STEWART KOLASCH & BIRCH, PO BOX 747, FALLS CHURCH, VA, 22040-0747, US

(21) Appl. No.: 12/796,081

(22) Filed: Jun. 8, 2010

Related U.S. Application Data
(63) Continuation of application No. PCT/FI2008/000133, filed on Nov. 27, 2008.

(30) Foreign Application Priority Data
Dec. 17, 2007 (FI) 20070987

(51) Int. Cl. B66B 5/28

(52) U.S. Cl. 187/343

(57) ABSTRACT

The object of the invention is a buffer arrangement of an elevator, which comprises at least the buffer (3a) of the elevator and a buffer stop (1), which buffer stop (1) comprises at least a stem part (4) fixed to its base (2) and a stop element (7) with adjustable height position fitted in connection with the stem part (4), which stop element comprises a stopping surface for the buffer (3a) of the elevator. An extension part (1b) is in connection with the buffer stop (1) for increasing the height position of the stopping surface of the buffer stop (1).

The object of the invention is a buffer arrangement of an elevator as defined in the preamble of claim 1 and a buffer stop of an elevator as defined in the preamble of claim 8.

In old buildings the pit at the bottom of the elevator shaft often does not meet modern safety requirements, e.g. in connection with servicing the elevator, because the height of the pit is in many cases too small with respect to the new safety requirements. It is often necessary in connection with modernization to take the new safety requirements of elevators into use at the same time, in which case when the old pit at the bottom of the elevator shaft is too shallow it has been necessary to deepen it so that new and stricter safety requirements could be met. Deepening the pit is, however, expensive and essentially slow.

The purpose of this invention is to eliminate the aforementioned drawbacks and to achieve a simple and low-cost buffer arrangement of an elevator, which enables meeting new safety requirements also in elevators that are to be modernized. The purpose of the invention is also to achieve a buffer arrangement of an elevator, in which the buffer stop can be easily and quickly activated, the threshold for use of which is small and which enables an adequately high safety space, i.e. protective space, e.g. in connection with servicing of the elevator. The buffer arrangement according to the invention is characterized by what is disclosed in the characterization part of claim 1.

The buffer stop according to the invention is characterized by what is disclosed in the characterization part of claim 8. Correspondingly, other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment of the invention can also be applied in other embodiments. In addition it can be stated that at least some of the subordinate claims can in at least some situations be deemed to be inventive in their own right.

An advantage of the buffer arrangement according to the invention is that when modernizing an elevator the pit in the floor of the shaft of the elevator does not need to be deepened, in which case expensive and essentially slow modification work is avoided. The buffer arrangement according to the invention is also very inexpensive compared to the heavy hydraulic buffer solutions nowadays in use. One advantage is also the ability for rapid installation and the fact that the buffer stop according to the arrangement can be used also on the roof of the elevator car or of the elevator shaft as well as in connection with the counterweight. Yet another advantage is that activation of the buffer stop according to the arrangement is quick and easy, in which case the threshold for activation is small, owing to which the buffer stop will often be activated during servicing work and thus the work safety of servicemen will improve.

In the following, the invention will be described in detail by the aid of one example of its embodiment with reference to the attached drawings, wherein

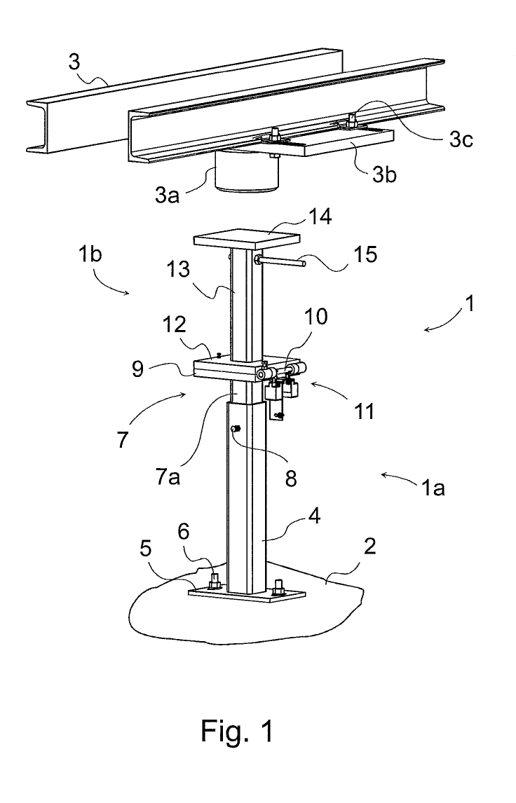

FIG. 1 presents a simplified and diagrammatic oblique top view of one buffer stop used in the arrangement according to the invention activated to service mode,

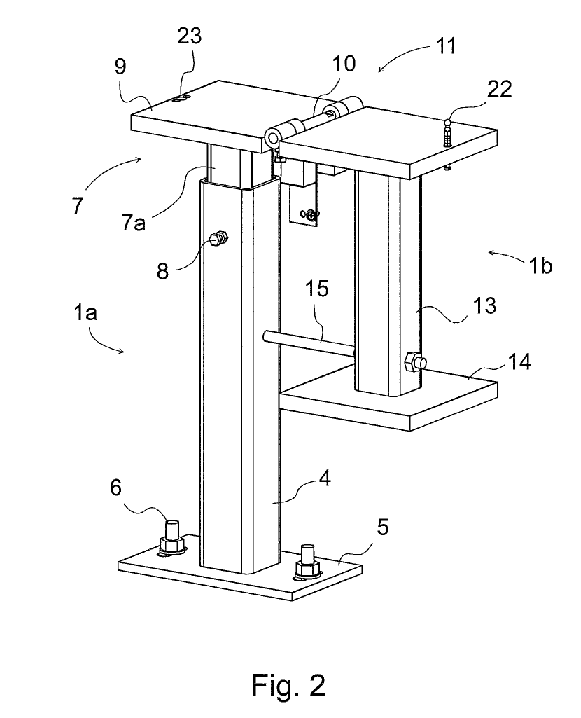

FIG. 2 presents a simplified and diagrammatic oblique top view of a buffer stop according to FIG. 1 in normal drive mode and

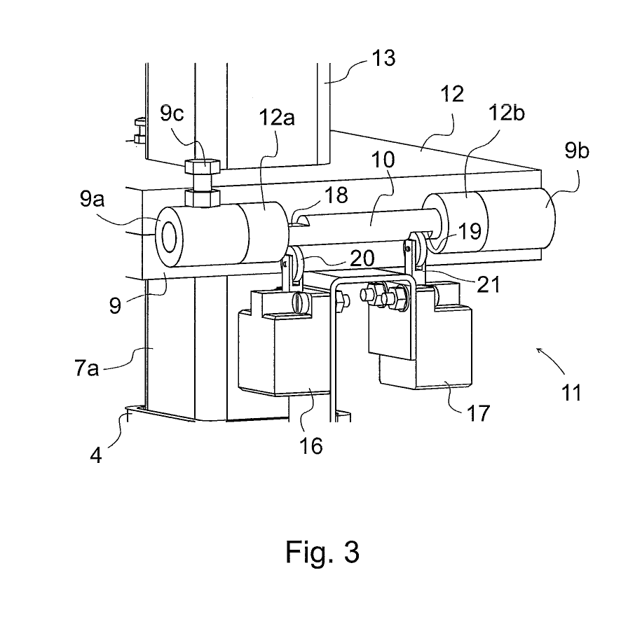

FIG. 3 presents a detail of the hinge structure of the buffer stop according to FIGS. 1 and 2 as viewed in the direction of the hinge.

FIG. 1 presents one buffer stop 1 used in the arrangement according to the invention when the elevator is in service mode. The buffer stop 1 is fixed in this solution e.g. to the floor 2 of the elevator shaft and disposed to point essentially vertically upwards. The other parts incorporated in the buffer arrangement are seen in FIG. 1 above the buffer stop 1, which parts are fixed to the bottom beams 3 of the car sling of the elevator car. The other parts are, among others, the actual buffer 3a as well as the mounting base 3b of the buffer and the fixing means 3c, with which the mounting base 3b is fixed to the bottom beams 3 of the car sling. The buffer 3a can be e.g. an elastomer buffer manufactured from polyurethane. The mounting base 3b of the buffer 3a is provided with e.g. elongated fixing holes, owing to which the mounting base 3b and at the same time the buffer 3a can be moved in the lateral direction into a better location, if e.g. there is not enough space directly in the center for the buffer stop 1 to behave in the manner according to the invention described below.

The buffer stop 1 of the buffer arrangement according to the invention comprises at least an elongated base part la and an extension part 1b that extends the length of the base part 1a in the height direction, i.e. in the direction of movement of the elevator car, which parts 1a and 1b are hinged to each other by means of a hinge element 11. The buffer stop 1 is disposed essentially directly below the path of movement of the buffer 3a such that in exceptional situations the buffer 3a hits the stopping surface of the buffer stop 1 preventing the elevator car from coming lower.

The base part 1a of the buffer stop 1 comprises at least a bottom flange 5 and an upward pointing hollow tubular stem part 4 fixed to it, which stem part 4 is e.g. square or rectangular piping. The stem part 4 is fixed via the bottom flange 5 and by means of the fixing elements 6 e.g. to the floor structure 2 of the elevator shaft. A stop element 7 provided with a telescopically moving vertical arm 7a is fitted inside the stem part 4, at the free end of which vertical arm 7a, i.e. at the top end in the solution presented here, is an upward pointing stop flange 9 provided with an essentially level stopping surface, against the stopping surface of which stop flange the elastomer buffer 3a is arranged to rest in the normal drive mode of the elevator if the elevator car for some reason drives so far downwards that the buffer 3a hits the stopping surface of the stop flange 9.

The position in the height direction of the stop element 7 and at the same time of the stop flange 9 is fitted to be adjustable by putting the desired amount of sand in the base of the hollow inside space of the stem part 4 of the base part 1a and by placing the vertical arm 7a, which is provided with a closed bottom end, of the stop element 7 to rest on the sand inside the stem part 4. In addition the stem part 4 comprises a locking screw 8 for locking the vertical arm 7a of the stop element 7 in position so that the stop element 7 could not e.g. accidentally be lifted out of its position.

The extension part 1b of the buffer stop 1 comprises an essentially straight tubular stem part 13, the first end of which, i.e. the end on the side of the base part 1a, comprises a plate-like support flange 12, and the other end of which, i.e. the free end, comprises a flange-like stopping element 14, which corresponds essentially in its size, shape and function to the stop flange 9 of the stop element 7 described above. The extension part 1b of the buffer stop 1 is hinged at one edge of the support flange 12 to one edge of the stop flange 9 of the stop element 7 by means of a hinge element 11 provided with a hinge pin 10.

FIG. 2 presents a buffer stop 1 according to FIG. 1 in the normal drive mode of the elevator. In this case the extension part 1b of the buffer stop 1 is bent by means of the hinge element 11 to the side such that the stopping surface of the stop flange 9 of the stop element 7 is fitted to receive a collision of the elastomer buffer 3a if the elevator car for some reason drives too far downwards. The stem part 13 of the extension part 1b comprises a support arm 15 at essentially a right angle with respect to the stem part 13, the length and position of which support arm is fitted to be such that when the extension part 1b is turned to the side out of the way of the stop flange 9, the free end of the support arm 15 rests on the outer surface of the stem part 4 of the base part 1a such that the arm 13 of the extension part 1b is in an essentially vertical position and the stopping surface of the stopping element 14 of the extension part 1b points downwards.

One edge of the support flange 12 of the extension part 1b also comprises a guide pin 22, which is fitted to correspond to the guide hole 23 on the edge of the stop flange 9 of the stop element 7 when the buffer stop 1 is activated for servicing or other corresponding procedure, such that the extension part 1b is turned onto the top of the base part la to extend the length of the base part 1a in the height direction. The purpose of the guide pin 22 and the guide hole 23 is to guide the extension part 1b to the correct position on top of the base part 1a. Preferably the guide pin 22 and the guide hole 23 are on the opposite edge with respect to the hinge element 11.

FIG. 3 presents the hinge element 11 in more detail. The hinge element 11 comprises e.g. at least the sleeve-like parts 9a and 9b that are provided with holes, which parts are fixed to one edge of the support flange 12 of the first end of the extension part 1b, and the sleeve-like parts 12a and 12b that are provided with holes, which parts are fixed correspondingly to one edge of the stop flange 9 of the stop element 7. The sleeve-like parts 9a, 9b and 12a, 12b are fixed in their position such that when the extension part 1b is in its position on top of the base part 1a the first sleeve-like parts 9a and 12a are side by side each other and correspondingly the second sleeve-like parts 9b and 12b are side by side each other as well as at a distance from the first sleeve-like parts. In addition the holes of all the sleeve-like parts 9a, 12a, 9b and 12b are essentially on the same axis, into which holes the shaft-like hinge pin 10 of the hinge element 11 is disposed, which hinge pin is locked into its correct attitude and position in the axial direction by means of the locking screw 9c e.g. through the sleeve-like part 9a. The hinge pin 10 is locked in its correct attitude to the first sleeve-like part 9a on the edge of the support flange 12 of the extension part 1b such that the hinge pin 10 rotates around its center axis as the extension part 1b is turned upwards or downwards.

The hinge pin 10 comprises two milled grooves 18 and 19 that narrow the hinge pin, in which the switch elements 20 and 21 of the position sensing switches 16 and 17 are disposed. The position sensing switches 16 and 17 are connected e.g. to the control system of the elevator and fitted to indicate to the control system of the elevator on the basis of the rotation of the hinge pin 10 in which position the extension part 1b of the buffer stop is at any time; either in normal drive mode, i.e. turned to the side and downwards, or in service mode, i.e. turned upright on top of the base part 1a.

The length of the extension part 1b is dimensioned with respect to the height of the base part 1a such that by means of the activation of the extension part 1b there is a possibility to increase the height of the protective space needed in connection with servicing of the elevator so that in a servicing situation or corresponding exceptional situation the height of the protective space or safety space according to safety requirements is reached if the pit has otherwise been too shallow e.g. in old buildings. Thus the combined height of the unextended buffer stop 1 and at the same time of the base part 1a and the extension part 1b of the buffer stop 1 is greater than or at least equal to the height of the safety space according to the safety requirements.

It is obvious to the person skilled in the art that the invention is not limited solely to the examples described above, but that it may be varied within the scope of the claims presented below. Thus for example the structure of the buffer and of the buffer stop can differ to what is presented above.

It is further obvious to the person skilled in the art that the buffer stop according to the invention can be disposed on the roof of the elevator car, on the roof of the elevator shaft or also under the counterweight instead of in the pit at the base of the elevator shaft.

It is also obvious to the person skilled in the art that the buffer stop according to the invention can be disposed in an inclined attitude with respect to its point-to-point measurement, in which case the extension part fits better for turning to the side or downwards in cramped locations.

It is further obvious to the person skilled in the art that the extension of the height of the buffer stop can be made in a different way to what is presented above. Thus in connection with extending the height it is possible to support the stop element e.g. with an extension arm provided with a hinge and a through-hole and the stop element can be lifted upwards by the necessary amount. In this case two different stopping surfaces are not needed, but instead the stopping surface of the stop element that operates in normal mode functions also as the stopping surface when the elevator is in service mode.

1. A buffer arrangement of an elevator, comprising:
at least the buffer of the elevator; and
a buffer stop, which buffer stop comprises:
at least a stem part fixed to a base thereof; and
a stop element with adjustable height position fitted in connection with the stem part, which stop element comprises a stopping surface for the buffer of the elevator, and an extension part is in connection with the buffer stop for increasing the height position of the stopping surface of the buffer stop,
wherein the extension part is hinged at a first end thereof by means of a hinge element to one edge of the stop flange in the stop element of the buffer stop.

2. Buffer The buffer arrangement according to claim 1, wherein the second end of the extension part comprises a stopping element provided with a stop surface, which is fitted to receive a collision of the buffer when the elevator is in service mode or in another corresponding mode.

3. Buffer The buffer arrangement according to claim 1, wherein in the normal drive mode of the elevator, the extension part of the buffer stop is fitted to turn around its hinge element to the side of the base part of the buffer stop and at the same time to reveal a stop surface thereof on the stop element of the buffer stop to receive a collision of the buffer.

4. The buffer arrangement according to claim 1, wherein in the service mode or other corresponding mode of the elevator, the extension part of the buffer stop is fitted to turn around its hinge element onto the top of the base part of the buffer stop and at the same time to activate the stop surface of a stopping element thereof at a second end thereof to receive a collision of the buffer.

5. The buffer arrangement according to claim 1, characterized in that wherein in connection with the hinge element are position sensor switches, which are connected to the control system of the elevator to indicate the current position of the extension part of the buffer stop.

6. Buffer The buffer arrangement according to claim 1, wherein the combined height of the unextended buffer stop and the extension part is greater than or at least equal to the height of the safety space according to the safety requirements.

7. The buffer arrangement according to claim 1, wherein the buffer is fixed to the elevator car or to another corresponding fixing point by means of a mounting base that is adjustable in the lateral direction.

8. A buffer stop of an elevator, comprising:
at least a stem part fixed to a base thereof; and
a stop element with adjustable height position fitted in connection with the stem part, which stop element comprises a stopping surface for the buffer of the elevator, and which buffer stop comprises an extension part,
wherein the extension part is hinged at a first end thereof by means of a hinge element to one edge of the stop flange in the stop element of the buffer stop and in that the extension part comprises a flange-like stopping element at a second end thereof.

9. The buffer arrangement according to claim 2, wherein in the normal drive mode of the elevator, the extension part of the buffer stop is fitted to turn around a hinge element thereof to the side of the base part of the buffer stop and at the same time to reveal a stop surface thereof on the stop element of the buffer stop to receive a collision of the buffer.

10. The buffer arrangement according to claim 2, wherein in the service mode or other corresponding mode of the elevator, the extension part of the buffer stop is fitted to turn around a hinge element thereof onto the top of the base part of the buffer stop and at the same time to activate the stop surface of a stopping element thereof at a second end thereof to receive a collision of the buffer.

11. The buffer arrangement according to claim 2, wherein in the service mode or other corresponding mode of the elevator, the extension part of the buffer stop is fitted to turn around a hinge element thereof onto the top of the base part of the buffer stop and at the same time to activate the stop surface of a stopping element thereof at a second end thereof to receive a collision of the buffer.

12. The buffer arrangement according to claim 2, wherein in connection with the hinge element are position sensor switches, which are connected to the control system of the elevator to indicate the current position of the extension part of the buffer stop.

13. The buffer arrangement according to claim 3, wherein in connection with the hinge element are position sensor switches, which are connected to the control system of the elevator to indicate the current position of the extension part of the buffer stop.

14. The buffer arrangement according to claim 4, wherein in connection with the hinge element are position sensor switches, which are connected to the control system of the elevator to indicate the current position of the extension part of the buffer stop.

15. The buffer arrangement according to claim 2, wherein the combined height of the unextended buffer stop and the extension part is greater than or at least equal to the height of the safety space according to the safety requirements.

16. The buffer arrangement according to claim 3, wherein the combined height of the unextended buffer stop and the extension part is greater than or at least equal to the height of the safety space according to the safety requirements.

17. The buffer arrangement according to claim 4, wherein the combined height of the unextended buffer stop and the extension part is greater than or at least equal to the height of the safety space according to the safety requirements.

18. The buffer arrangement according to claim 5, wherein the combined height of the unextended buffer stop and the extension part is greater than or at least equal to the height of the safety space according to the safety requirements.

19. The buffer arrangement according to claim 2, wherein the buffer is fixed to the elevator car or to another corresponding fixing point by means of a mounting base that is adjustable in the lateral direction.

20. The buffer arrangement according to claim 3, wherein the buffer is fixed to the elevator car or to another corresponding fixing point by means of a mounting base that is adjustable in the lateral direction.
